(19) United States
(12) Patent Application Publication
(10) Pub. No.: US 2009/0122966 A1
(43) Pub. Date: May 14, 2009

(54) Controlling Voice Mail Systems From Instant Messaging Clients

(75) Inventor: Jeffrey G. Gartner, Hopewell Junction, NY (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/939,263

(22) Filed: Nov. 13, 2007

(51) Int. Cl. H04M 1/64

(52) U.S. Cl. 379/88.12

(57) ABSTRACT

A method of controlling a voice mail system with an instant messaging client is disclosed. For example, the illustrative embodiment enables a user of a instant messaging client to forward a voice mail message to one or more people listed in the instant messaging client's buddy list. Furthermore, the instant messaging client also enables the user to annotate the voice mail message and to send the voice mail commentary alone with the voice mail message to one or more people listed in the instant messaging client's buddy list.

### FIELD OF THE INVENTION

The present invention relates to telecommunications in general, and, more particularly, to instant messaging and voice mail systems.

### BACKGROUND OF THE INVENTION

Instant messaging is form of real-time communication between two or more people based on typed text. The text is conveyed by data processing systems (e.g., computers, personal digital assistants, Blackberrys, etc.) over a network such as the Internet or an intranet.

Instant messaging offers real-time communication and allows easy collaboration, which might be considered more akin to genuine conversation than e-mail's store and forward/retrieve mechanism. In contrast to e-mail, the Instant Messaging parties know whether the peer is available via a Presence Service that is inherent in the Instant Messaging system. Most Instant Messaging systems allow the user to set an online status or away message so peers are notified when the user is available, busy, or away from the computer or do so automatically based on the user's activity level on their computer or activity within the Instant Messaging system itself. In most cases, the user is allowed to manually override the automated presence state. On the other hand, recipients of instant messages do not necessarily have to respond immediately to incoming messages. For this reason, users consider communication via instant messaging to be less intrusive than communication via telephone. However, some systems allow the sending of messages to people not currently logged on (offline messages), thus removing much of the difference between instant messaging and email.

### SUMMARY OF THE INVENTION

The present invention provides a method of controlling a voice mail system without some of the costs and disadvantages for doing so in the prior art. For example, the illustrative embodiment enables a user of a instant messaging client to forward a voice mail message to one or more people listed in the instant messaging client's buddy list. Furthermore, the instant messaging client also enables the user to annotate the voice mail message and to send the voice mail commentary alone with the voice mail message to one or more people listed in the instant messaging client's buddy list.

The illustrative embodiment comprises: receiving an indication of the existence of a voice mail message in a voice mailbox associated with a first user; selecting an indicium of a second user from a buddy list in an instant messaging client; and forwarding the voice mail message to a second voice mailbox associated with the second user.

### BRIEF DESCRIPTION OF THE DRAWINGS

FIG. 1 depicts a block diagram of the salient components of the illustrative embodiment of the present invention.

FIG. 2 depicts a block diagram of the salient components of data processing system 102-i, which comprises: processor 201-i, memory 202-i, instant messaging client 203-i, graphical user interface 204-i, microphone 205-i, and speaker 206-i, interconnected as shown.

FIG. 3 depicts a drawing of a window in the graphic user interface on data processing system 101-1, which window is instant messaging client 203-1.

FIG. 4 depicts a block diagram of the salient components of voice mail system 103, which comprises processor 401 and memory 402, interconnected as shown.

FIG. 5 depicts a flow chart of the salient tasks associated with the performance of the illustrative embodiment of the present invention.

### DETAILED DESCRIPTION

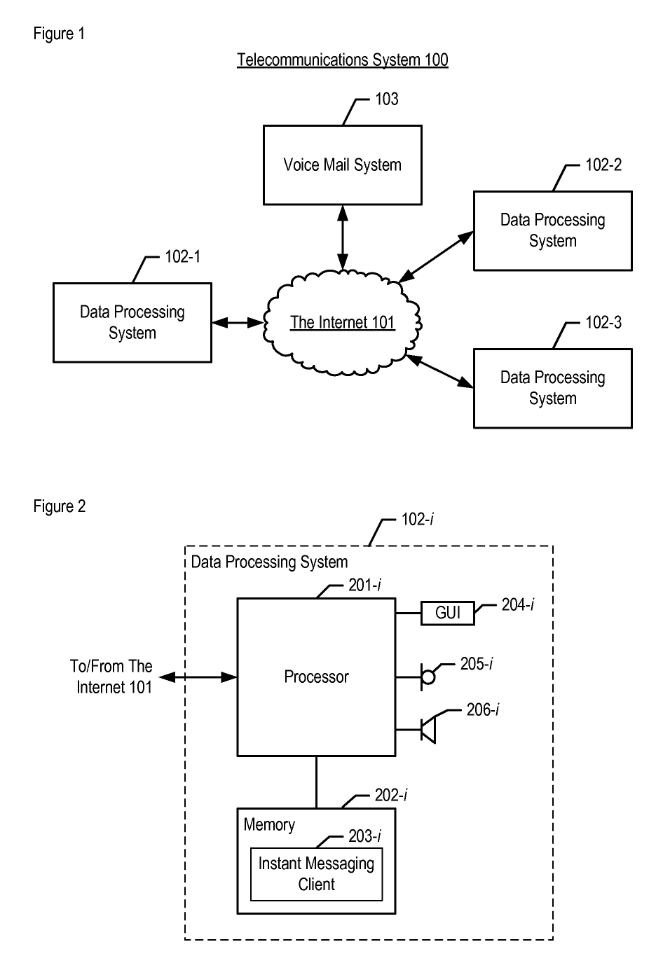

FIG. 1 depicts a block diagram of the salient components of the illustrative embodiment of the present invention. Telecommunications system 100 comprises: the Internet 101, data processing systems 102-1 through 102-3, and voice mail system 103, interconnected as shown.

Although the illustrative embodiment depicts three data processing systems, it will be clear to those skilled in the art, after reading this disclosure, how to make and use alternative embodiments of the present invention that use any number of data processing systems.

The Internet 101 is the ubiquitous packet network and it will be clear to those skilled in the art how to extend and use the Internet. Although the illustrative embodiment uses the Internet as the communications network through with the data processing systems and voice mail system 103 communicate, it will be clear to those skilled in the art, after reading this disclosure, how to make and use alternative embodiments of the present invention that use any telecommunications network (e.g., the Public Switched Telephone Network, a wireless network, an IBM SNA network, etc.).

Data processing system 102-i, wherein i is a member of the set {1, 2, 3}, comprises hardware and software for performing the tasks described below and in the accompanying figures. In accordance with the illustrative embodiment, each of data processing systems 102-1, 102-2, and 102-3 are connected to the Internet 101 via a wireline connection, but it will be clear to those skilled in the art, after reading this disclosure, how to make and use alternative embodiments of the present invention in which any or all of the data processing systems are connected to the Internet 101 via a wireless connection.

In accordance with the illustrative embodiment, each of data processing systems 102-1, 102-2, and 102-3 are identical, but it will be clear to those skilled in the art, after reading this disclosure, how to make and use alternative embodiments of the present invention in which any or all of the data processing systems are not identical.

Voice mail system 103 comprises hardware and software for receiving, storing, forwarding, and playing voice mail messages as described below and in the accompanying figures.

FIG. 2 depicts a block diagram of the salient components of data processing system 102-i, which comprises: processor 201-i, memory 202-i, instant messaging client 203-i, graphical user interface 204-i, microphone 205-i, and speaker 206-i, interconnected as shown.

Processor 201-i is hardware, as is well known in the prior art, for executing commands in memory 202-i, for storing into and retrieving data from memory 202-i, for transmitting packets to and receiving packets from the Internet, and for interfacing with graphical user interface 204-i, microphone 205-i, and speaker 206-i. It will be clear to those skilled in the art how to make and use processor 201-i.

Memory 202-i is a non-volatile storage, as is well known in the art, for storing programs and data, including instant messaging client 203-i. It will be clear to those skilled in the art how to make and use memory 202-i.

Instant messaging client 203-i is a program that transmits text and audio in accordance with the instant messaging protocol and in the manner described in detail below and in the accompanying figure.

Graphical user interface 204-i comprises a display, keyboard, and pointing device for enabling a user of data processing system 102-i to control data processing system 102-i in general and instant messaging client 203-i in particular. It will be clear to those skilled in the art how to make and use graphical user interface 204-i.

Microphone 205-i is an electro-acoustic transducer for converting an acoustic signal (e.g., speech, etc.) into an electromagnetic representation of that acoustic signal. It will be clear to those skilled in the art how to make and use microphone 205-i.

Speaker 206-i is an electro-acoustic transducer for converting an electro-magnetic signal into an acoustic representation of that electromagnetic signal. It will be clear to those skilled in the art how to make and use speaker 206-i.

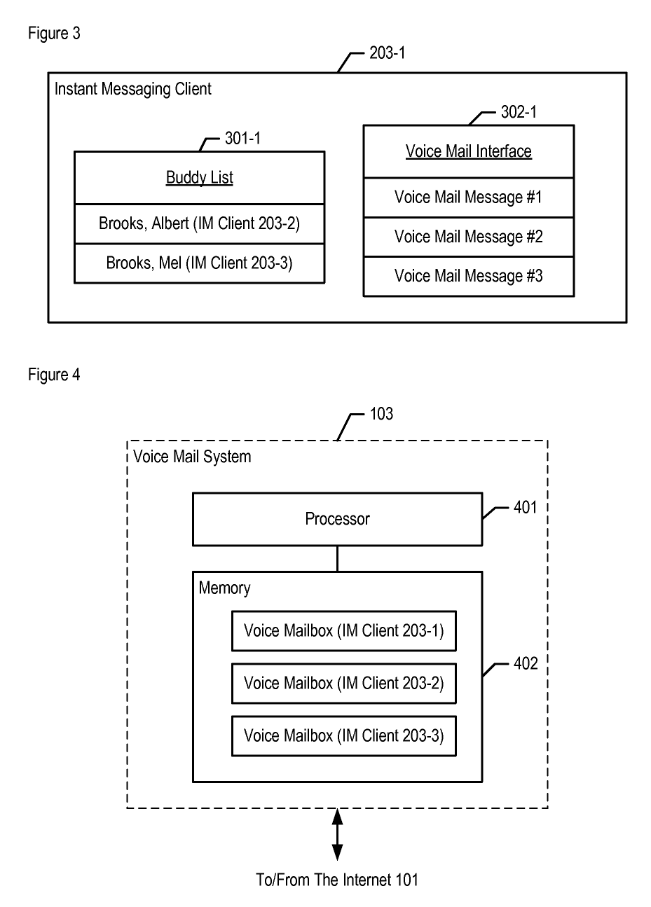

FIG. 3 depicts a drawing of a window in the graphic user interface on data processing system 101-1, which window is instant messaging client 203-1. Instant messaging client 203-1 comprises two panes: buddy list 301-1 and voice mail interface 302-1.

Buddy list 301-1 is a list of the names of people (and their associated instant messaging client addresses) who the user of instant messaging client 203-1 frequently chats with via instant messaging client 203-1. Buddy list is created and maintained by the user of instant messaging client 203-1. Buddy list 301-1 is used as described in detail below and in the accompanying figures.

Voice mail interface 302-1 is a list of the voice mails in the voice mailbox in voice mail system 103 for the user of instant messaging client 203-1. In accordance with the illustrative embodiment, voice mail interface 302-1 is a voice-mail interface that is embedded in instant messaging client 203-1. Voice mail interface 302-1 is used as described in detail below and in the accompanying figures.

FIG. 4 depicts a block diagram of the salient components of voice mail system 103, which comprises processor 401 and memory 402, interconnected as shown.

Processor 401 is hardware, as is well known in the art, for executing commands in memory 402, for storing and playing voice mail messages in memory 402, and for receiving commands from instant messaging client 203-i to manage the voice mail messages in memory 402. It will be clear to those skilled in the art how to make and use processor 401.

Memory 402 is a non-volatile storage, as is well known in the art, for storing programs and data, including a plurality of voicemail boxes for each user of instant messaging client 203-i. It will be clear to those skilled in the art how to make and use memory 402.

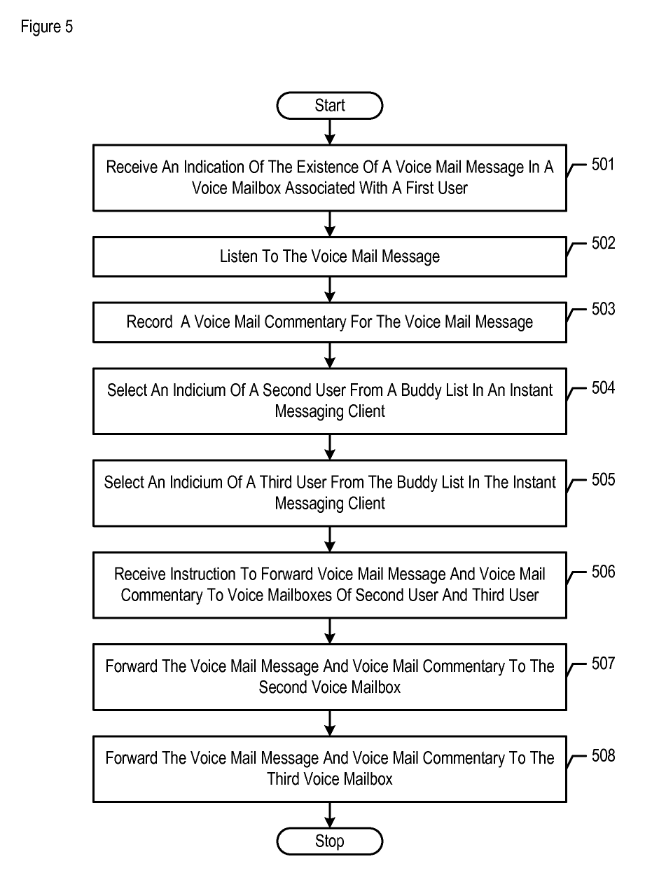

FIG. 5 depicts a flow chart of the salient tasks associated with the performance of the illustrative embodiment of the present invention.

At task 501, a first user, who is using data processing system 102-1 and instant messaging client 203-1, receives an indication of the existence of a voice mail message in his or her voice mailbox. This indication is given to the first user via data processing system 102-1 and voice mail interface 302-1 in well-known fashion.

At task 502, the first user, using voice mail interface 302-1, directs voice mail system 103 to play the voice mail message to him or her via data processing system 102-1. As a consequence of what the first user hears, the first user decides to comment on the voice mail message and to forward the voice mail message and voice mail commentary to two users who are on buddy list 301-1. These tasks are performed in the following tasks.

Although the illustrative embodiment adds a commentary to the voice mail message, it will be clear to those skilled in the art, after reading this disclosure, how to make and use alternative embodiments of the present invention in which no commentary is added. Furthermore, although the illustrative embodiment forwards the voice mail message and commentary to two voice mailboxes, it will be clear to those skilled in the art, after reading this disclosure, how to make and use alternative embodiments of the present invention in which the voice mail message is sent to any number of voice mailboxes. And still furthermore, although the illustrative embodiment sends the voice mail commentary to all of the voice mailboxes who receive the voice mail message, it will be clear to those skilled in the art, after reading this disclosure, how to make and use alternative embodiments of the present invention in which any subset of the voice mailboxes to which the voice mail message is sent are also sent the voice mail commentary.

At task 503, the first user, using voice mail interface 302-1, records a voice mail commentary, which is the first user's annotations on the voice mail message. In accordance with the illustrative embodiment, the voice mail commentary is stored in memory 402 of voice mail system 103, but it will be clear to those skilled in the art, after reading this disclosure, how to make and use alternative embodiments of the present invention in which the voice mail commentary is stored elsewhere. Furthermore, although in accordance with the illustrative embodiment, the voice mail commentary is an audio recording of speech, it will be clear to those skilled in the art, after reading this disclosure, how to make and use alternative embodiments of the present invention in which the voice mail commentary is text or video.

At task 504, the first user selects a second user (e.g., Albert Brooks, etc.) from buddy list 301-1. The illustrative embodiment comprises a graphical user interface, and, therefore, this is accomplished by “dragging and dropping” or “pointing and clicking on” or selecting the second user's name in buddy list 301-1. It will be clear to those skilled in the art, after reading this disclosure, how to make and use alternative embodiments of the present invention in which a different method is used to select the second user from buddy list 301-1.

At task 505, the first user selects a third user (e.g., Mel Brooks, etc.) from buddy list 301-1. The illustrative embodiment comprises a graphical user interface, and, therefore, this is accomplished by “shift-clicking” or additionally selecting the third user's name in buddy list 301-1. It will be clear to those skilled in the art, after reading this disclosure, how to make and use alternative embodiments of the present invention in which a different method is used to select the third user's name from buddy list 301-1. In accordance with the illustrative embodiment, two users from buddy list 301-1 are selected, but it will be clear to those skilled in the art, after reading this disclosure, how to make and use alternative embodiments of the present invention in which any number of users are selected.

At task 506, the first user instructs instant messaging client 203-1 to instruct voice mail system 103 to forward the voice mail message and the voice mail commentary to the voice mailboxes of the second and third users.

At task 507, voice mail system 103 forwards the voice mail message and the voice mail commentary to the voice mailbox associated with the second user. As part of task 507, the second user is informed of the existence of the voice mail message and the voice mail commentary via his or her instant messaging client.

At task 508, voice mail system 103 forwards the voice mail message and the voice mail commentary to the voice mailbox associated with the third user. As part of task 508, the third user is informed of the existence of the voice mail message and the voice mail commentary via his or her instant messaging client.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving an indication of the existence of a voice mail message in a voice mailbox associated with a first user;
selecting an indicium of a second user from a buddy list in an instant messaging client; and
forwarding the voice mail message to a second voice mailbox associated with the second user.

2. The method of claim 1 further comprising:
selecting an indicium of a third user from the buddy list in the instant messaging client; and
forwarding the voice mail message to a third voice mailbox associated with the third user.

3. The method of claim 1 further comprising:
recording a voice mail commentary for the voice mail message; and
forwarding the voice mail commentary for the voice mail message to the second voice mailbox.

4. A method comprising:
receiving an indication of the existence of a voice mail message in a voice mailbox associated with a first user;
recording a voice mail commentary for the voice mail message;
selecting an indicium of a second user from a buddy list in an instant messaging client; and
forwarding the voice mail message and the voice mail commentary to a second voice mailbox associated with the second user.

5. The method of claim 4 further comprising:
selecting an indicium of a third user from the buddy list in the instant messaging client; and
forwarding the voice mail message and the voice mail commentary to a third voice mailbox associated with the third user.

6. A method comprising:
receiving an indication of the existence of a voice mail message in a voice mailbox associated with a first user;
selecting an indicium of a second user from a buddy list in an instant messaging client;
selecting an indicium of a third user from the buddy list in the instant messaging client;
forwarding the voice mail message to a second voice mailbox associated with the second user; and
forwarding the voice mail message to a third voice mailbox associated with the third user.

7. The method comprising:
recording a voice mail commentary for the voice mail message; and
forwarding the voice mail commentary for the voice mail message to the second voice mailbox; and
forwarding the voice mail commentary for the voice mail message to the third voice mailbox.
